(19) United States
(12) Patent Application Publication
(10) Pub. No.: US 2017/0120202 A1
(43) Pub. Date: May 4, 2017

(54) BATHWATER CIRCULATING SYSTEM AND METHOD OF OPERATING SAME

(71) Applicant: Franz Kaldewei GmbH & Co. KG, Ahlen (DE)

(72) Inventors: Thomas SCHMIDT, Muenster (DE); Tobias Meyer, Warendorf (DE)

(21) Appl. No.: 15/342,506

(22) Filed: Nov. 3, 2016

(30) Foreign Application Priority Data
Nov. 4, 2015 (DE) 102015118942.9

(51) Int. Cl. B01F 3/04; F04D 31/00; B01F 15/02; F04D 29/42; B01F 5/16; B01F 13/04; F04D 15/00; F04D 1/00

(52) U.S. Cl. CPC B01F 3/0451; F04D 15/0022; F04D 31/00; F04D 1/00; F04D 29/4293; F04D 29/4206; B01F 5/16; B01F 13/042; B01F 15/026; B01F 15/0292; A61H 33/0087

(57) ABSTRACT

A bathwater circulating system has a pump operable to draw fluid in at an intake port and expel it under pressure at an output port. Water- and air-supply conduits feed water and air to the intake port at a rate determined by a flow-restricting air-intake valve so that the pump mixes the water and the air, pressurizes the mixture and thereby dissolves the air in the water, and expels the air/water mixture at the output port. A pressure-reducing valve is connected by an output conduit that extends from the output port to the pressure relief valve and conducts the water/air-bubble mixture from the pump to the pressure-reducing valve without separation of the air from the water and such that the mixture is at least partially depressurized at the pressure-reducing valve such that the air forms microbubbles in the water.

### FIELD OF THE INVENTION

The present invention relates to a bathwater circulating system. More particularly this invention concerns a bathtub with such a system and to a method of operating the system.

### BACKGROUND OF THE INVENTION

A typical bathwater circulating system for producing a mixture of water and air bubbles has a pump, an air-supply conduit provided with an inflow regulator, in particular an intake valve, and connected to a water-supply conduit that is in turn connected to an intake port of the pump having an output port connected to a pressure-reducing valve. This system is typically used with a bathing vessel that can for example be a bathtub, a seated bath, a foot bath or even a washbasin.

The bathwater circulating system is provided for producing particularly fine bubbles that are barely perceptible to a user, which bubbles can accordingly also be called microbubbles.

Thus the bathwater circulating system according to the invention thus differs from conventional whirlpool systems in which air and bathwater are mixed together directly in a whirlpool nozzle, so that a highly effervescent effect and, depending on the design, also a massage jet can be produced. However, the bathwater circulating system according to the invention can also be combined with known whirlpool systems in order to make possible a greater spectrum of function. A user is then free to choose gentle treatment with the bathwater circulating system according to the invention or also an exhilarating massage function with a conventional whirlpool system or even to combine them with each other.

The microbubbles produced by the bathwater circulating system are very fine and their structure is reminiscent of a mist or a very fine foam. This has a vitalizing effect on the skin of a user, and also a particularly gentle, pleasant tingling can be noticed.

The operation of the bathwater circulating system involves ambient air or another gas being pressurized and then dissolved in the bathwater such as a result, the smallest microbubbles can form in the air/water mixture due to decompression.

A bathwater circulating system with the features as described above is known from JP 2008-290050. In this system, bathwater is drawn out of a filled bathtub by a pump and mixed with ambient air upstream of the pump. The air/water mixture is pressurized by the pump such that some of the ambient air dissolves in the bathwater.

The mixture is then fed to a fluid-settling chamber in which excess ambient air in the form of large bubbles remaining in the mixture can be eliminated. By separating the liquid phase from the gas phase, ambient air in the bathwater drawn off from the fluid-settling chamber is present exclusively in dissolved form. The bathwater with the ambient air dissolved therein is then guided into a throttle or flow-impeding device with nozzle constrictions where, due to the drop in pressure at the flow-impeding device, the ambient air previously dissolved in the bathwater is released in the form of very fine bubbles accordingly called microbubbles.

A bathwater circulating system is known from U.S. Pat. Nos. 8,579,266, 8,720,867, and 9,060,916 (EP 2 226 056, EP 2 226 057, and EP 2 703 071) in which bathwater is drawn in by a pump and, immediately after the bathwater is pressurized by the pump, a gas, in particular ambient air, is added. The thus formed air/water mixture is fed into a fluid-settling chamber to separate off the excess ambient air.

A similar arrangement is described in WO 2007/051260 where the bathwater is enriched with ozone.

According to DE 20 2011 110 581, bathwater is enriched with CO₂ that is taken from gas container, and an equalizing container is arranged downstream of the pump.

### OBJECTS OF THE INVENTION

It is therefore an object of the present invention to provide an improved bathwater circulating system.

Another object is the provision of such an improved bathwater circulating system that overcomes the above-given disadvantages, in particular that is simply designed, cost-effectively produced, and can be operated with little outlay on maintenance.

Furthermore, a bathtub with a corresponding bathwater circulating system and a method of operating the bathwater circulating system is to be provided.

### SUMMARY OF THE INVENTION

A bathwater circulating system has according to the invention a pump having an intake port and an output port and operable to draw fluid in at the intake port and expel it under pressure at the output port. A water-supply conduit connected to a water supply and to the intake port feeds water from the water supply to the intake port. An air-supply conduit connected to the water-supply conduit and provided with a flow-restricting air-intake valve feeds air to the intake port at a rate determined by the flow-restricting air-intake valve so that the pump mixes the water and the air, pressurizes the mixture and thereby dissolves the air in the water, and expels the air/water mixture at the output port. A pressure-reducing valve is connected by a first output conduit that extends from the output port to the pressure relief valve and conducts the water/air-bubble mixture from the pump to the pressure-reducing valve without separation of the air from the water and such that the mixture is at least partially depressurized at the pressure-reducing valve such that the air forms microbubbles in the water.

Thus, starting from a bathwater circulating system with the features described above a pressure-reducing valve is connected, as flow-impeding device, preferably to an output conduit directly at an outlet of the pump, without a fluid-settling chamber to separate bubbles being provided therebetween.

According to the invention, a fluid-settling chamber always provided according to the state of the art is dispensed with, and the pressure, flow and quantity ratios of bathwater and ambient air can be set such that the aspirated ambient air on the pressure side can fully, or at least to a large extent, dissolve in the bathwater due on the one hand to the pressure-reducing valve and on the other hand to the inflow restriction, in particular the intake valve, for the aspirated ambient air, with the result that none, or no substantial quantity, of the undissolved ambient air remains upstream of the pressure-reducing valve, and thus the formation of small bubbles, which can also be called microbubbles, is not, or at least not substantially, impaired.

Within the framework of the invention, only a particularly small amount of operating noise is generated in order not to impair the well-being of a user. Also against this background, it is advantageous to dispense with the fluid-settling chamber, because this can serve as a type of resonator to amplify noise in the known designs. Furthermore, eliminating larger bubbles in a fluid-settling chamber by bursting individual bubbles, according to the state of the art, leads to higher operating noise which, depending on the design, can also be perceived as a sort of bubbling. Also, changes in cross-section occur at the transitions in the fluid-settling chamber, which can also lead to flow noises.

In respect of the development of noise, preferably plastic hoses and tubes are used for pipe installation that have less transmission of noise in comparison with metal pipes.

The bathwater circulating system according to the invention is preferably provided for circulating the bathwater that has already been drawn out of the bathtub. Also, the bathwater circulating system can also, or alternatively, be operated with fresh water or at least a portion of fresh water, and optionally also a mixture or a change-over between circulated bathwater and fresh water can take place.

According to the invention, a fluid-settling chamber is dispensed with, with the result that the preferably provided output conduit between the outlet of the pump and the pressure-reducing valve has a constant cross-section over its entire length, according to a preferred design of the invention. The output conduit can be, for example, a simple pipe or a tube.

In order to ensure, within the piping, that the ambient air can dissolve sufficiently in the bathwater provided, a sufficient length of output conduit is to be provided. Preferably, the output conduit between the pump output port and the pressure-reducing valve can be more than 100 mm, particularly preferably more than 300 mm, for example between 350 mm and 500 mm, long. In principle, the longer the output conduit, the better the mixture, and the higher the degree of saturation of ambient air in the bathwater.

The pressure-reducing valve is necessary to build up a backpressure against the pump on the one hand, in order to be able to dissolve the ambient air in the bathwater.

The parameters of the pressure-reducing valve and the pump are preferably matched to one another such that, when operating the bathwater circulating system to produce microbubbles in the output conduit vis-à-vis the ambient pressure of the bathtub, a superatmospheric pressure of, for example, 2.5 bar to 7 bar, preferably between 3.5 bar and 5 bar, results. As the superatmospheric pressure increases, so too does the quantity of ambient air that can be dissolved in the bathwater. On the other hand, the bathwater circulating system is also to be operated safely in as simple a design as possible, which is why even higher pressures can be disadvantageous.

Also, the drop in pressure at the pressure-reducing valve is the cause of the formation of microbubbles because, as the pressure in the bathwater falls abruptly, the solubility of the ambient air decreases, and thus microbubbles form. In order to be able to form as many very small bubbles as possible, an abrupt drop in pressure is advantageous.

In addition to just the drop in pressure, the changes in cross-section at the pressure-reducing valve can lead to a formation of microbubbles in the form of cavitation. Optimal operating properties can be found easily within the framework of the invention by tests, even if the effects leading to a formation of bubbles cannot be quantified and distinguished individually for a specific arrangement.

The danger downstream of the pressure-reducing valve is, in principle, that the produced small bubbles (microbubbles) join together and thus form larger bubbles that are less able to produce the desired soft pearlescent effect for a user. Against this background, too great a distance between the pressure-reducing valve and a fluid outlet of the bathtub can be disadvantageous.

Surprisingly, the formation and stability of microbubbles can also be improved by normal bath additives such as for example bath oil, bath salt, alcohol, soap or the like, because such additives can prevent coalescence of the microbubbles, that is merging of the microbubbles to form larger bubbles. It is also assumed that by reducing the surface tension with the named bath additives, even smaller froth bubbles, which are more pleasant for the user, can be formed.

As already explained above, according to the present invention, the flow rates of bathwater and ambient air as well as the flow and pressure ratios of the fluids or fluid mixtures are intended to be set such that a complete or at least extensive dissolving of the ambient air in the bathwater occurs, accompanied by pressurization, eliminating the need for an additional fluid-settling chamber. The quantity of aspirated ambient air is determined by the (static and dynamic) subatmospheric pressure on the intake port of the pump as well as the intake valve. Preferably, it is an adjustable valve, in particular a needle metering valve, with which a fine adjustment is possible. In principle, however, a different valve or a set diaphragm also comes into consideration.

As the bathwater circulating system consists of components that are matched to one another, a suitable setting of such an adjustable valve can be predetermined on site and then, if necessary, adjustment or correction is possible during installation or maintenance.

The bathwater circulating system can be designed and arranged such that the adjustable intake valve can be accessed directly or after removing a cover, inspection flap or the like. In principle, a remote adjustment can also be provided by a Bowden cable or other mechanical couplings. Finally, an electronic control is also possible, for which corresponding actuators or mounts are to be provided at the adjustable intake valve.

As already described above, in the event of a specific flow rate, the pressure-reducing valve effects a backing-up and thus also the required drop in pressure, and, when microbubbles are produced, the pressure-reducing valve is located in a flow-impeding position greatly reducing its flow cross-section. Preferably, this flow-impeding position can also be changed either at the pressure-reducing valve for set-up purposes and maintenance purposes, or even via a remote adjustment mechanism.

In principle, the pressure-reducing valve and the intake valve in a device can be adjusted such that stable and advantageous operating parameters result even at different operating parameters such as, for example, varying water temperature. The operating position of the intake valve and the pressure-reducing valve are then changed only for maintenance purposes.

Such a design of the bathwater circulating system is also advantageous from a practical point of view, and also in respect to overall cost, and is generally wholly sufficient for satisfying the requirements of a user.

In principle, however, also a variable electronic control of the intake valve and/or of the pressure-reducing valve and/or of the pump is also possible in order to be able to further influence the production of microbubbles. If, for example, bubbles of different strengths are to be produced, throughput in the pump can be increased, and optionally the position of the intake valve and of the pressure-reducing valve in its flow-impeding position are then to be adapted accordingly. Different sensors, such as for example temperature sensors, can also be provided for an electronic control, because the solubility of air in water also depends on the temperature.

In order to produce microbubbles, according to the invention, in agreement with the state of the art, a flow-impeding device is necessary that within the framework of the invention is designed as a pressure-reducing valve. At the valve gap necessary for the production of microbubbles, particles and other impurities may also accumulate, with the result that it may clog. As bathwater circulates, impurities from the bathtub can also be carried along.

In order to make possible a self-acting, automatic cleaning, according to a preferred design of the invention, the pressure-reducing valve has a pressure-controlled adjustment mechanism in order to move it between a flow-impeding position or a full-open position, dependent on pressure.

When operating the bathwater circulating system for producing bubbles, such a pressure-reducing valve is automatically in the flow-impeding position. If, on the other hand, the pump is shut down and the pressure built up by the pump is below a predetermined threshold value, the pressure-reducing valve shifts to an open position in which a greater flow cross-section is opened up.

Both due to the trailing bathwater and also the renewed start-up of the bathwater circulating system upstream of closing the pressure-reducing valve, impurities are flushed from the then opened gap.

Within the framework of the invention, preferably a centrifugal pump is provided as pump. The pump is to be chosen such that, at the lowest possible cost and a low development of noise, a good thorough mixing of the drawn-out bathwater and aspirated ambient air is achieved.

The subject matter of the invention is also a bathtub, in particular with and the bathwater circulating system described above. The bathtub can for example also be a sitz bath, a foot bath, a washbasin or the like. The intake port of the pump is connected to a drain or intake opening of the bathtub, and the exit of the pump is connected to a fluid outlet of the bathtub via the output conduit and the pressure-reducing valve and preferably a second output conduit connecting the pressure-reducing valve to the fluid outlet. If the intake port of the pump is connected to a drain opening of the bathtub, an integrated design with a drain is the result. However, the bathwater can be drawn away also separately by an intake opening, which is located, like a drain opening, on the bottom or also a side wall of the bathtub.

The fluid outlet can be located in particular on a side wall or on the bottom of the bathtub. Also, the fluid outlet can in principle be combined with an inlet or outlet. Furthermore, a combination with a further functional element, for example a whirl nozzle or a light, is also possible.

Finally, the invention also relates to a method of operating the bathwater circulating system described above, on a bathtub. For this, bathwater is drawn at the intake port of the pump out of the filled bathtub, and, in the drawn-out bathwater, a subatmospheric pressure is produced on the intake port of the pump vis-à-vis the ambient pressure, with the result that ambient air is drawn in via the air-supply conduit connected to the intake valve. The intake can be produced both by a dynamic subatmospheric pressure according to the Venturi principle and also by a static subatmospheric pressure on the intake port, and, self-evidently, both effects can be combined with each other.

The mixture of drawn-out bathwater and aspirated ambient air is drawn in by the pump and pressurized, and the ambient air is dissolved at least partly in the bathwater when pressurized. The bathwater with the ambient air at least partially dissolved therein is then decompressed at the pressure-reducing valve so that a mixture of bathwater and bubbles, in particular very fine bubbles, forms. Finally, the mixture of bathwater and bubbles is let out into the bathtub.

The flow rate of the bathwater at the intake port is preferably between 10 l/min (liters per minute) and 20 l/min, and—relative to the volume under ambient pressure—the flow rate of the ambient air there is between 0.5 l/min and 2 l/min, with the result that a volume ratio of between 10:2 and 40:1, preferably approximately 10:1, results for the drawn-out bathwater and the aspirated ambient air.

The mixture of drawn-out bathwater and aspirated ambient air is pressurized by the pump relative to ambient pressure, to a superatmospheric pressure of between preferably 2.5 bar to 7 bar, and particularly preferably between 3.5 bar and 5 bar.

As already explained above, according to a preferred embodiment of the invention, the pressure-reducing valve has a pressure-controlled adjustment mechanism in order to move between a flow-impeding position and an open position. Correspondingly, according to a preferred embodiment of the method the pressure-reducing valve automatically shifts from a flow-impeding position into an open position after switching off the pump and correspondingly a drop-off in superatmospheric pressure and opens up an enlarged flow cross-section. Cleaning takes already by running the drawn-out bathwater through the pressure-reducing valve.

Furthermore, when switching on the pump, impurities from the still open pressure-reducing valve can be flushed out after of the pressure-reducing valve automatically shifts from the open position to the flow-impeding position by a corresponding pressure control. Such a pressure control can for example be achieved by a spring-loaded valve body that has differently sized end faces, each of which is pressurized with the fluid on one side of the pressure-reducing valve.

Each pressure-reducing valve is inventive on its own, and also a use of differently designed bathwater circulating systems, in particular bathwater circulating systems, is possible.

### BRIEF DESCRIPTION OF THE DRAWING

The above and other objects, features, and advantages will become more readily apparent from the following description, reference being made to the accompanying drawing in which:

FIG. 1 is a perspective view with a bathwater circulating system according to the invention;

FIG. 2 a perspective detail view showing only the bathwater circulating system;

FIG. 3 is a schematic view of the bathwater circulating system;

FIG. 4 is a diagram showing how the bathwater circulating system works;

FIG. 5A is a large-scale perspective view of the valve of the supply system in one end position;

FIG. 5B is a view like FIG. 5A but in an opposite end position;

FIGS. 6A and 6B are views like FIGS. 5A and 5b showing a second embodiment of the valve; and

FIGS. 7A and 7B are views like FIGS. 5A and 5b showing a third embodiment of the valve.

### SPECIFIC DESCRIPTION OF THE INVENTION

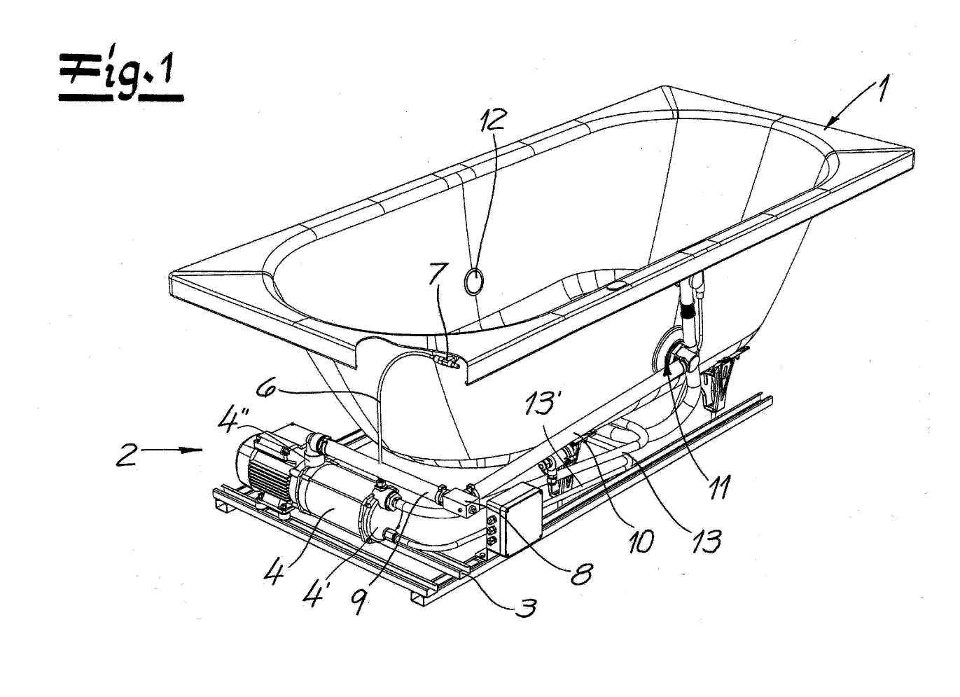

As seen in FIG. 1, a bathtub 1 sitting on a base 3 has a bathwater circulating system 2 that circulates bathwater through the bathtub 1. This bathwater is provided according to the invention with small bubbles in order to increase well-being for a user and achieve a positive influence on the skin of a user.

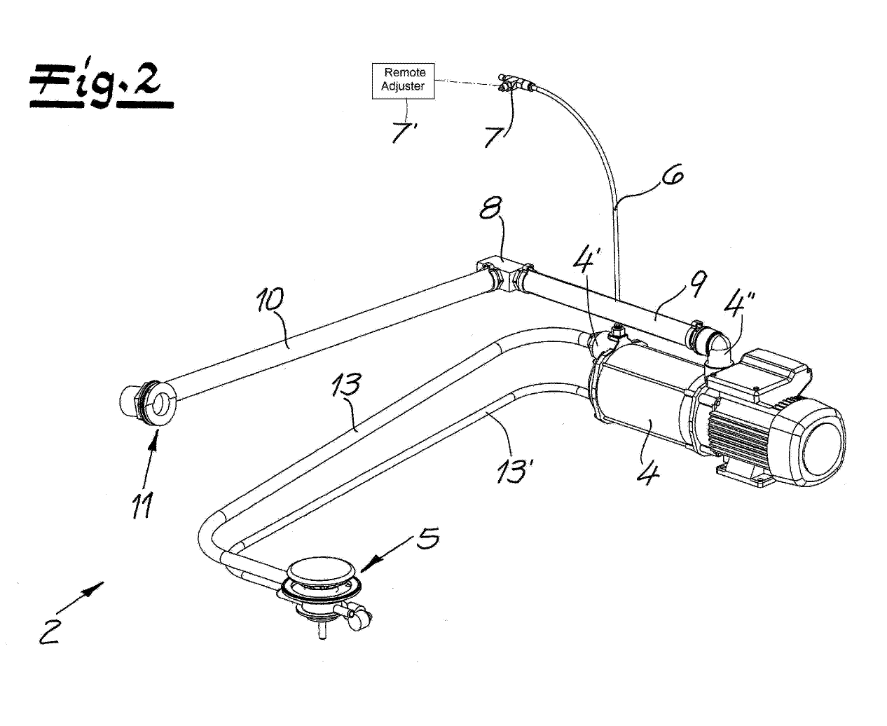

FIGS. 1 and 2 show how a centrifugal pump 4 having an intake port 4′ and an output port 4″ draws bathwater out of the tub 1 through a floor drain 5 connected to the intake port 4′. An air-supply conduit 6 having an intake valve 7 is also connected to the intake port 4′. An intake valve 7 at an upstream end of the air-supply conduit 6 is below an upper edge of the tub 1, and is preferably a needle valve that makes possible a precise dosing of the ambient air that is drawn in there. Preferably, the intake valve 7 can be adjusted directly by hand or with a tool, and it is normally protected by an inspection flap or a cover, or can also be mounted to be freely accessible. In the case of free accessibility, the intake valve can be arranged for example at an upper section of the tub 1 (e.g. outer edge or upper flange). However, in principle, a mechanical or electronic remote adjustment is also possible so that the intake valve 7 can then also be mounted in an inaccessible location.

The subatmospheric pressure produced by the pump 4 is so large that not only bathwater is drawn out of the tub 1 and into the intake port 4′, but also ambient air is drawn in through the air-supply conduit 6 and the intake valve 7. Thus a mixture of drawn-out bathwater and aspirated ambient air also forms at the intake port 4′. The bathwater circulating system 2 is preferably operated such that the flow rate of the bathwater is between 10 l/min and 20 l/min, and the flow rate of ambient air relative to the volume in ambient pressure is between 0.5 l/min and 2 l/min. The mixture of bathwater and ambient air is pressurized by the pump 4 and accordingly at a superatmospheric pressure at the output port 4″ of the pump 4.

A pressure-reducing valve 8 that serves to build up superatmospheric pressure is connected by a conduit 9 without a chamber for separating the bubbles to the output port 4″ of the pump 4. That is, the output conduit 9 is of substantially uniform or the same flow cross section between the output port 4″ and the valve 8 so that the mixture of water and air outputted by the pump 4 does not separate between the output port 4″ and the valve 8. On the one hand, this pressure-reducing valve 8 serves to hold back the mixture of bathwater and ambient air from the pump 4 to a certain degree and thus to pressurize it with a predetermined superatmospheric pressure. The ambient air thus dissolves into the bathwater in the conduit 9 due to the superatmospheric pressure in the conduit 9 and the thorough mixing of the bathwater and the air in the pump 4. In comparison with ambient pressure, the superatmospheric pressure can for example be 2.5 to 7 bar, in particular 3.5 to 5 bar and particularly preferably 4 to 4.5 bar.

The pressure and flow conditions and the flow rates of bathwater and ambient air are chosen such that the ambient air can dissolve in the bathwater to a large extent, or preferably completely or almost completely, with the result that no, or only very few, air bubbles reach the pressure-reducing valve 8.

In order to achieve as thorough and as complete as possible mixing and dissolving, the conduit 9 in the form of a pipe or a tube is preferably more than 100 mm long, particularly preferably more than 300 mm long. In principle, to achieve as complete a solution as possible, a significant length is advantageous.

An abrupt drop in pressure takes place at the pressure-reducing valve 8 so that the solubility of ambient air in the bathwater decreases accordingly and very small bubbles are formed. The mixture of bathwater and very small bubbles formed in the pressure-reducing valve 8 flows via a second output conduit 10 connected to the pressure-reducing valve 8 to a bubble-water outlet 11 of the tub 1, here located on a side wall of the tub 1. The mixture of bathwater and very small bubbles is ejected at the fluid outlet 11 into the tub 1 that is filled with bathwater above the level of this fluid outlet 11.

The particularly delicate bubbles are sensed by a user as pleasant and invigorating. Due to the large number of very small bubbles, the bathwater clouds up and becomes milky, and in the embodiment of FIG. 1 a lamp 12 is provided opposite the fluid outlet 11 such that light emitted by the lamp 12 is uniformly scattered to create a particularly harmonious color impression, and light refraction at the small bubbles also enhances this milky haze.

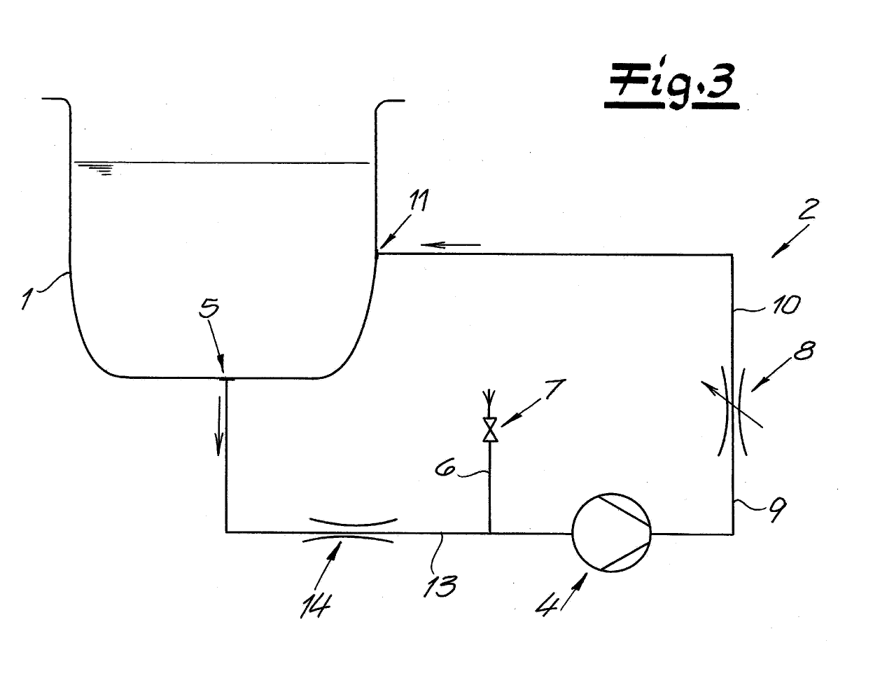

As shown in FIG. 3, the bathwater is then drawn out of the tub 1 at the outlet 5, and a flow-impeding effect is achieved either by the cross-section of a water-supply conduit 13 connecting the outlet 5 to the pump 4 or an additional diaphragm 14 is provided in the water-intake conduit 13 such that a subatmospheric pressure results in water-supply conduit 13 and as a result ambient air is drawn in through air-supply conduit 6 and the intake valve 7. FIGS. 1 and 2 show a return conduit 13′ below the intake conduit 13 and serving to drain residual water from the pump 4 back into the tub at the outlet 5.

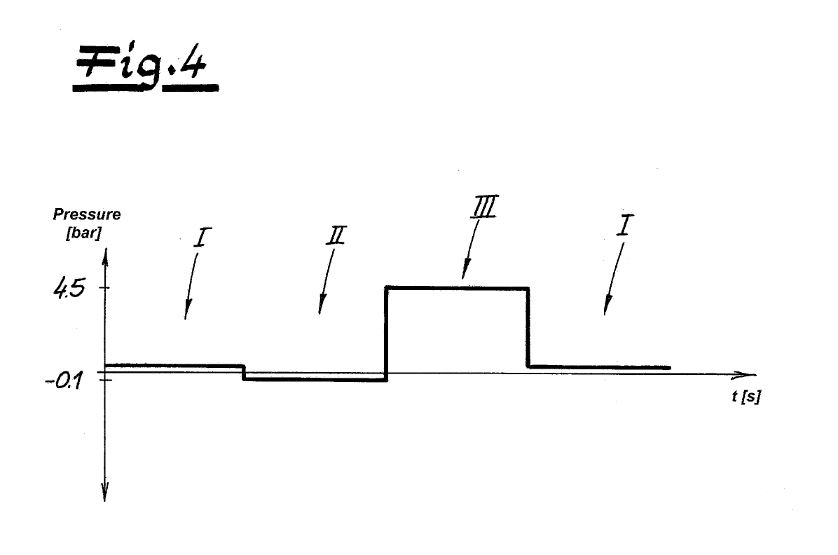

The pressure profile is shown in the different areas purely schematically in FIG. 4. There, a first pressure I that is slightly above ambient pressure is produced within the tub 1 due to the water column there. A subatmospheric pressure II of, for example, −0.1 bar, below ambient pressure, is then set in water-supply conduit 13 due to the suction of the pump 4, with the result that air is drawn in.

The mixture of ambient air and bathwater is then pressurized with superatmospheric pressure III by the pump 4 in combination with the downstream pressure-reducing valve 8, which pressure can for example be between 4 and 4.5 bar. Because of the superatmospheric pressure III, air within the conduit 9 dissolves into the bathwater and, according to the invention, due to the suitable matching of the interacting components, a separate fluid-settling chamber for separating excess ambient air is not needed.

An abrupt drop in pressure takes place at the pressure-reducing valve 8, accompanied by the formation of very delicate microbubbles, and pressure downstream of the pressure-reducing valve 8 corresponds approximately to the pressure inside the tub 1. In the purely schematic representation of FIG. 4, for reasons of simplicity, pressure differences due to the different heights of the water column at the floor drain 5 and outlet 11 are not taken into consideration.

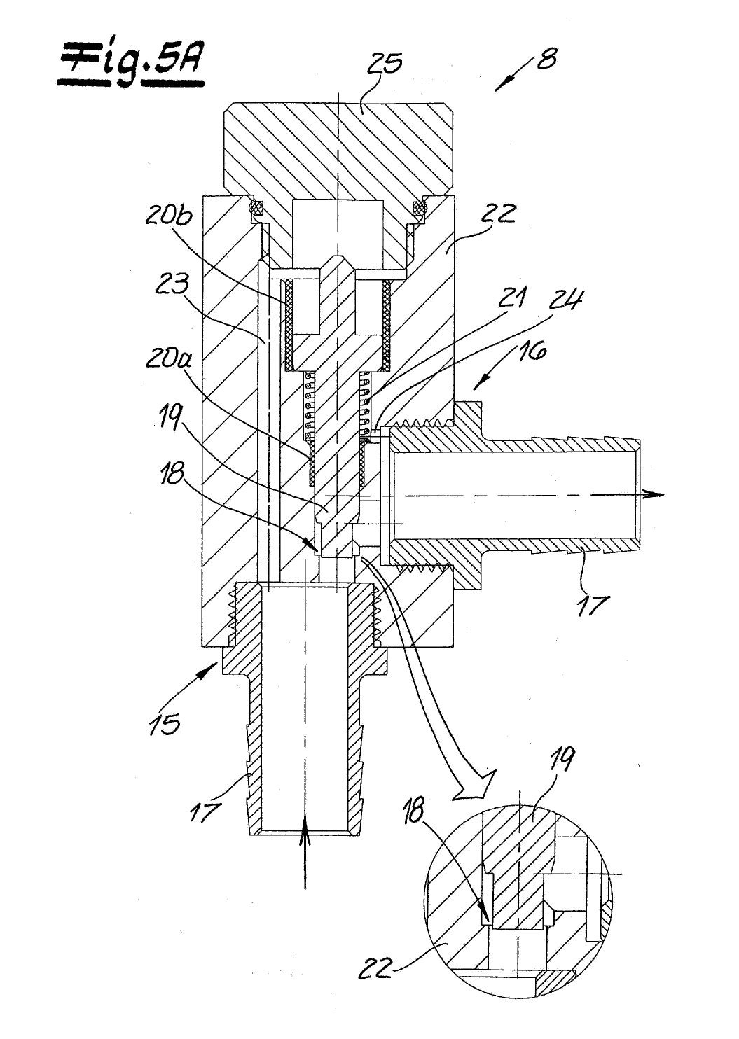

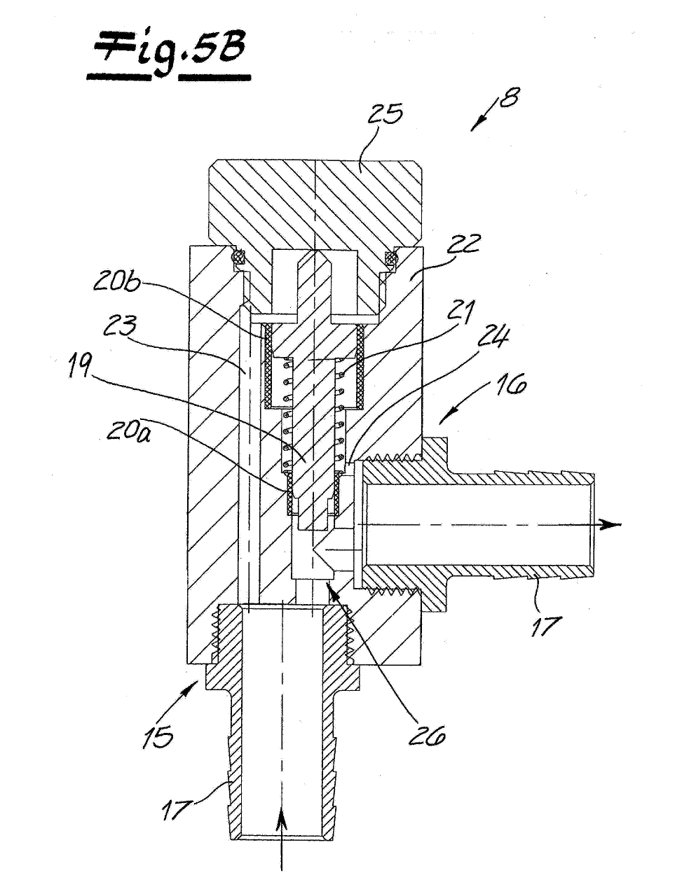

FIG. 5A shows a preferred embodiment of the pressure-reducing valve 8 that has a hose connection 17 both at an inlet 15 and also at the an outlet 16. The pressure-reducing valve 8 is in a flow-impeding throttle position in which only a small annular gap 18 is opened up by a valve body 19. This valve body 19 is axially slidable on bushings 20a and 20b and a spring 21 presses against it to force it inside a valve housing 22 of the pressure-reducing valve 8 toward an open position away from the inlet 15 (see FIG. 5B).

In order that valve body 19 can assume the flow-impeding position against the force of the spring 21 according to FIG. 5A, the valve housing 22 has a bypass passage 23 extending from the inlet 15 to a rear face of the valve body 19 turned away from the inlet 15. The valve body 19 has a stepped shape between the bushings 20a and 20b so that it is brought into the flow-impeding position in the event of a superatmospheric pressure at the inlet 15, since its rear face pressurized through the passage 23 is much larger than its front face exposed at the inlet 15. To equalize pressure, the region of valve body 19 around the spring 21 is connected to the outlet 16 via a vent passage 24.

The valve body 19 can be accessed by removing a plug 25 for maintenance and cleaning purposes. This plug 25 is screwed into a rear end of the valve housing 22.

If the pump 4 is switched off so that superatmospheric pressure ceases to exist at the inlet 15, the spring 21 pushes the valve body 19 axially rearward into an open position shown in FIG. 5B, and a passage 26 of a greater flow cross-section is opened up within the pressure-reducing valve 8 for free flow between the inlet 15 and outlet 16. Impurities previously held back at the annular gap 18 can thus be discharged. In principle, in a modification of this embodiment, the valve body 19 can also be shaped such it is scraped clean on movement into the open position by interacting with the bushing 20a and valve housing 22.

Impurities initially held back at annular gap 18 can be discharged, for example when draining bathwater after opening the pressure-reducing valve 8 or when using the bathwater circulating system, before the valve body 19 moves into the flow-impeding position under pressure control.

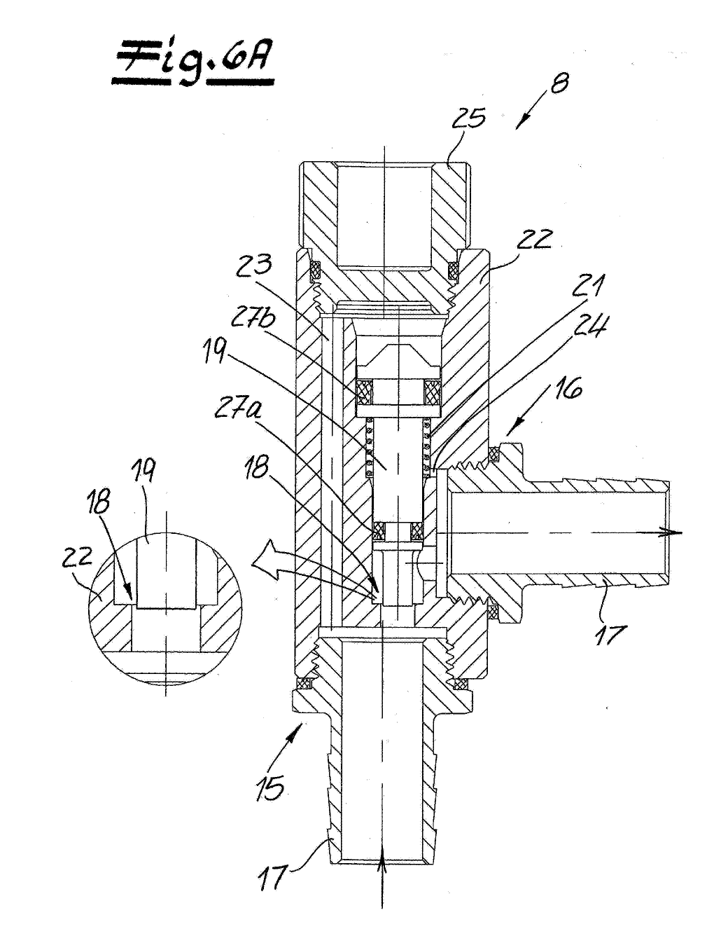

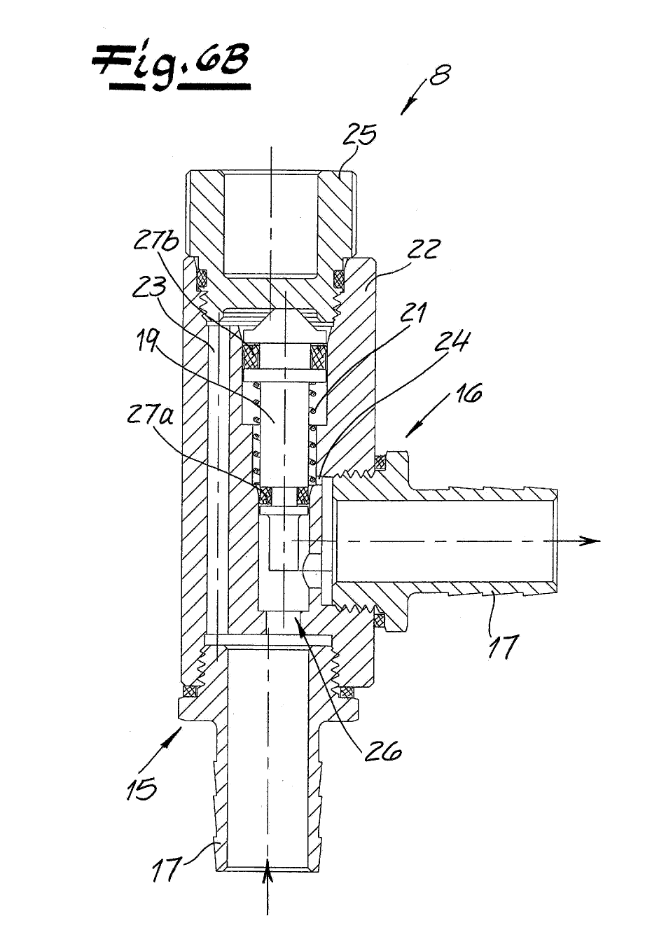

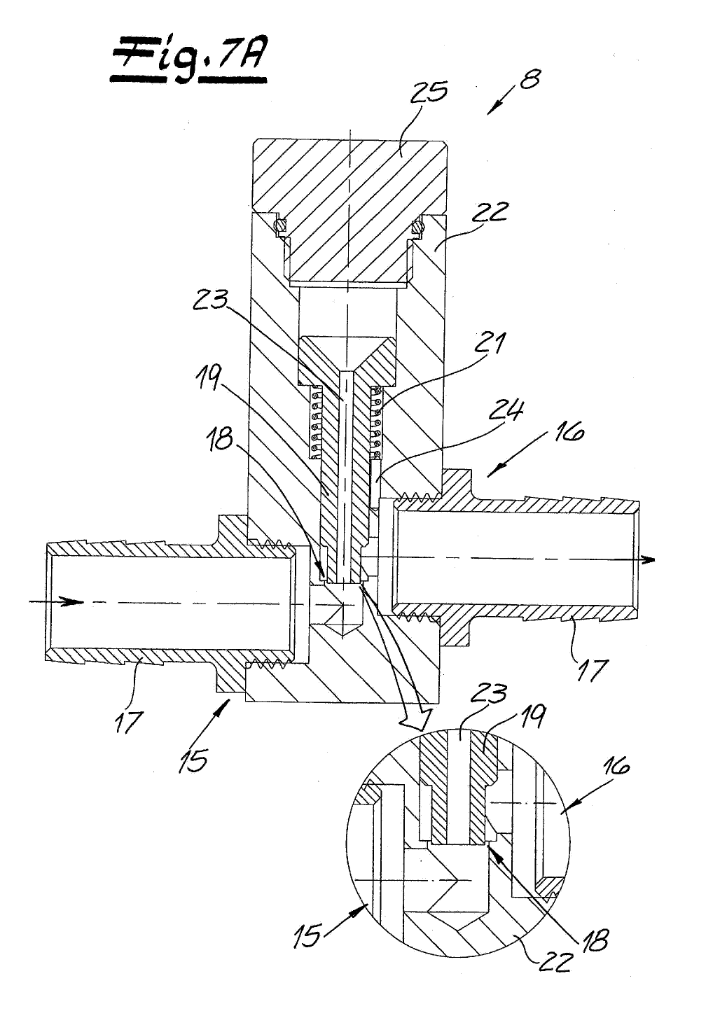

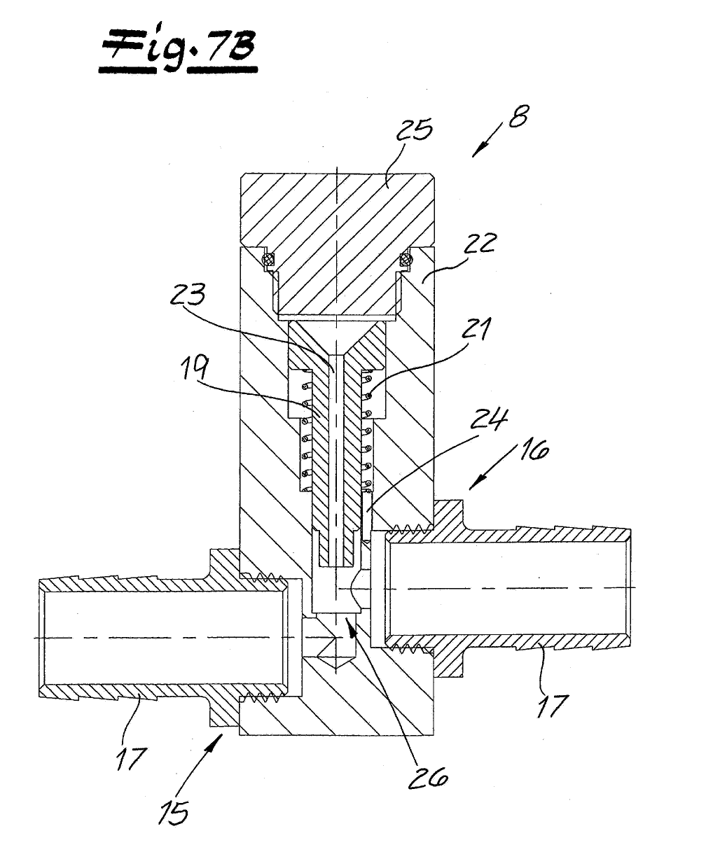

FIGS. 6A and 6B or 7A and 7B show alternative designs of the pressure-reducing valve 8 in the flow-impeding position and in the open position.

In the second embodiment of FIGS. 6A and 6B, seals 27a, 27b are provided instead of slide bushings 20a and 20b, as a modification vis-à-vis the pressure-reducing valve 8 described above. Each such seals is set in a respective groove of the valve body 19. The slide bushings 20a and 20b or seals 27a, 27b are advantageously chosen such that valve body 19 can slide easily, as a small amount leakage past them is acceptable.

FIGS. 7A and 7B show that the bypass passage 23 is formed not in the valve housing 22 but in the valve body 19. The automatic cleaning effect described above takes place to the same degree.

We claim:

1. A bathwater circulating system comprising:
a pump having an intake port and an output port and operable to draw fluid in at the intake port and expel it under pressure at the output port;
a water-supply conduit connected to a water supply and to the intake port and feeding water from the water supply to the intake port;
an air-supply conduit connected to the water-supply conduit, provided with a flow-restricting air-intake valve, and feeding air to the intake port at a rate determined by the flow-restricting air-intake valve, whereby the pump mixes the water and the air, pressurizes the mixture and thereby dissolves the air in the water, and expels the air/water mixture at the output port;
a pressure-reducing valve; and
a first output conduit leading from the output port to the pressure relief valve and conducting the water/air-bubble mixture from the pump to the pressure-reducing valve without separation of the air from the water and such that the mixture is at least partially depressurized at the pressure-reducing valve such that the air forms microbubbles in the water.

2. The bathwater circulating system defined in claim 1, and the first output conduit extends without interruption from the output port of the pump to the pressure-reducing valve.

3. The bathwater circulating system defined in claim 1, and the first output conduit is a tube or hose more than 100 mm long.

4. The bathwater circulating system defined in claim 1 wherein the first output conduit has a uniform flow cross-section between the pump output port and the pressure-reducing valve.

5. The bathwater circulating system defined in claim 1, and the pressure-reducing valve has a pressure-controlled adjusting mechanism in order to move between a flow-impeding position or an open position, depending on pressure.

6. The bathwater circulating system defined in claim 5, and the flow-impeding position is adjustable.

7. The bathwater circulating system defined in claim 1, and the flow-restricting air-intake valve is an air-inflow regulator.

8. The bathwater circulating system defined in claim 1, and the air-intake valve is an adjustable needle valve.

9. The bathwater circulating system defined in claim 1, and the air-intake valve is provided with a remote adjustment mechanism.

10. The bathwater circulating system defined in claim 1 wherein the pump is a centrifugal pump.

11. The bathwater circulating system defined in claim 1,
further comprising:
a second output conduit connected to the pressure-reducing valve.

12. The bathwater circulating system defined in claim 11, further comprising:
a bathtub holding a body of bathwater and forming the water supply, the second output conduit and the water supply conduit opening into the bathtub.

13. A method of operating a bathwater circulating system, the method comprising the steps of:
drawing bathwater out of a bathtub and conducting the drawn-out bathwater to an intake port of a pump;
aspirating and supplying ambient air to the drawn-out bathwater generally at the intake port via an air-supply conduit provided with a flow-restricting valve;
operating the pump to take in and mix the drawn-out water and air from the air-supply conduit such that the air from the air-supply conduit is dissolved in the drawn out water;
feeding the mixture from the pump through a first output conduit to a pressure reducing valve without substantially depressurizing the mixture;
reducing pressure of the mixture at the pressure-reducing valve such that air in the mixture forms microbubbles in the water; and
expelling the water with the microbubbles from the pressure-reducing valve into the bathtub.

14. The method defined in claim 13, and the bathwater is fed to the intake port at a flow rate of between 10 l/min and 20 l/min.

15. The method defined in claim 13, and the ambient air is fed to the intake port at a flow rate of between 0.5 l/min and 2 l/min.

16. The method defined in claim 13, and the pump pressurizes the mixture of drawn-out bathwater and aspirated ambient air with a superatmospheric pressure of between 2.5 bar and 7 bar.

17. The method defined in claim 16 wherein the superatmospheric pressure is between 3.5 bar and 5 bar.

18. The method defined in claim 13, further comprising the step of:
switching the pressure-reducing valve automatically between a flow-impeding position to an open position after switching off the pump so as to opens up an enlarged flow cross-section through the pressure-reducing valve.

19. The method defined in claim 17, further comprising the step, when the pump is switched on with the pressure-reducing valve in the open position, of:
flushing impurities from the pressure-reducing valve before moving the pressure-reducing valve automatically from the open position to the flow-impeding position.
